(19) United States
(12) Patent Application Publication
(10) Pub. No.: US 2020/0068939 A1
(43) Pub. Date: Mar. 5, 2020

(54) Nutritional compositions to increase and sustain blood ketone levels

(71) Applicant: JHO Intellectual Property Holdings LLC, Davie, FL (US)

(72) Inventor: John H. Owoc, Weston, FL (US)

(21) Appl. No.: 16/120,690

(22) Filed: Sep. 4, 2018

(51) Int. Cl. A23L 33/175; A23L 33/16; A23L 33/12; A23P 10/40; A23L 2/52

(52) U.S. Cl. CPC A23L 33/175; A23L 33/16; A23V 2002/00; A23P 10/40; A23L 2/52; A23L 33/12

(57) ABSTRACT

This invention discloses a nutritional composition of matter that effectively reduces and stabilize glucose levels in the blood of mammals by deliberately inducing ketosis. The compositions comprise, Sodium Beta-Hydroxybutyrate, Potassium Beta-Hydroxybutyrate, Magnesium Beta-Hydroxybutyrate, Calcium Beta-Hydroxybutyrate, Ketone Esters, Medium Chain Triglycerides (MCT) with at least one or more from L-Leucine, L-Lysine, L-isoleucine, Caffeine, Yohimbine, Yohimbe, Berberine and Creatine or its derivatives (such as creatine salt, and Creatyl-L-leucine).

The present invention relates to oral compositions of matter that increase and maintain blood ketone levels in mammals. More specifically it relates to the administration of a nutritional composition of matter that effectively increases and maintains ketone levels in the blood of mammals, including humans without the need of dietary restrictions. The compositions potentiate a mixture of medium chain triglycerides, ketogenic amino acids, ketone esters and a mixture of ketone bodies. The described composition may optionally be further potentiated by including isoleucine, caffeine, berberine, yohimbine, yohimbe, creatine, creatine-amino acid peptides (e.g., Creatyl-L-leucine), and other creatine derivatives.

### BACKGROUND OF THE INVENTION

Ketosis is a metabolic state in which some of the body's energy supply comes from ketone bodies in the blood, in contrast to a state of glycolysis in which blood glucose provides energy. Ketosis is a result of metabolizing fat to provide energy.

Ketosis is a nutritional process characterized by serum concentrations of ketone bodies over 0.5 mM/L, with low and stable levels of insulin and blood glucose. It is almost always generalized with hyperketonemia, that is, an elevated level of ketone bodies in the blood throughout the body.

Ketone bodies are formed by ketogenesis when liver glycogen stores are depleted (or from metabolizing medium-chain triglycerides). The main ketone bodies used for energy are acetoacetate and β-hydroxybutyrate (bHB), and the levels of ketone bodies are regulated mainly by insulin and glucagon. Most cells in the body can use both glucose and ketone bodies for fuel, and during ketosis, free fatty acids and glucose synthesis (gluconeogenesis) fuel the remainder.

Longer-term ketosis may result from fasting or staying on a low-carbohydrate diet (ketogenic diet) and/or incorporating such dietary protocols as a 4:1 fat to protein ratio while keeping dietary carbohydrate intake as low as possible.

Deliberately induced ketosis serves as a medical intervention for various conditions, such as intractable epilepsy, various types of diabetes and maybe be helpful with certain types of cancer etc. which require glucose.

In glycolysis, higher levels of insulin promote storage of body fat and block release of fat from adipose tissues. Conversely, while in ketosis, fat reserves are readily released and may be oxidized or burned as a preferential fuel source. For this reason, ketosis is sometimes referred to as the body's “fat burning” mode.

It should be noted that states of ketosis and ketogenic diets are at least in part effective for weight and fat loss because of the natural overall calorie reduction that takes place when eliminating carbohydrates—one of the most pervasive of all macro-nutrients from the diet. Nothing has been proven more effective for weight loss than calorie deficit diets.

Ketone bodies (KBs) can be utilized as a fuel source by peripheral tissues including muscle, but also exert a range of metabolic effects including anti-catabolic effects on muscle and attenuation of glucose utilization and lipolysis. Egan B, and D'Agostino D. (Cell Metabolism 24, Sep. 13, 2016) demonstrated rapid bioavailability of ketone esters, KE (573 mg/kg) with bHB rising to ˜6 mM at 30 min after ingestion at rest

A study by Stubbs, B J et al, (Obesity (Silver Spring). 2018 February; 26(2): 269-273 doi:10.1002/oby.22051. Epub 2017 Nov. 6), investigated the effects of exogenous ketone ester (KE) on appetite. Following an overnight fast, subjects with normal weight (n=15) consumed 1.9 kcal/kg of KE, or isocaloric dextrose (DEXT), in drinks matched for volume, taste, tonicity, and color. Blood samples were analyzed for bHB, glucose, insulin, ghrelin, glucagon-like peptide 1 (GLP-1), and peptide tyrosine tyrosine (PYY), and a three-measure visual analogue scale was used to measure hunger, fullness, and desire to eat. RESULTS: KE consumption increased blood bHB levels from 0.2 to 3.3 mM after 60 minutes. DEXT consumption increased plasma glucose levels between 30 and 60 minutes. Postprandial plasma insulin, ghrelin, GLP-1, and PYY levels were significantly lower 2 to 4 hours after KE consumption, compared with DEXT consumption. Temporally related to the observed suppression of ghrelin, reported hunger and desire to eat were also significantly suppressed 1.5 hours after consumption of KE, compared with consumption of DEXT.

In separate study Evans M, et al (J Physiol. 2017 May 1; 595(9):2857-2871. Doi:10.1113/JP273185. Epub December 7) established the physiological basis for exogenous supplementation of ketone bodies. Recent development of ketone esters facilitates acute ingestion of βHB that results in nutritional ketosis without necessitating restrictive dietary practices. Initial reports suggest this strategy alters the metabolic response to exercise and improves exercise performance, while other lines of evidence suggest roles in recovery from exercise.

Trevor O'Malley et al investigated the impact of raising plasma beta-hydroxybutyrate (Beta-OHB) through ingestion of ketone salts on substrate oxidation and performance during cycling exercise (Applied Physiology, Nutrition, and Metabolism, 2017, 42(10): 1031-1035, https://doi.org/10.1139/apnm-2016-0641). Ten healthy adult males (age, 23±3 years; body mass index, 25±3 kg/m², peak oxygen uptake, 45±10 mL/(kg·min)⁻¹) were recruited to complete 2 experimental trials. Before enrollment in the experimental conditions, baseline anthropometrics and cardiorespiratory fitness (peak oxygen uptake) were assessed and familiarization to the study protocol was provided. On experimental days, participants reported to the laboratory in the fasted state and consumed either 0.3 g/kg β-OHB ketone salts or a flavour-matched placebo at 30 min prior to engaging in cycling exercise. Subjects completed steady-state exercise at 30%, 60%, and 90% ventilatory threshold (VT) followed by a 150-kJ cycling time-trial. Respiratory exchange ratio (RER) and total substrate oxidation were derived from indirect calorimetry. Plasma glucose, lactate, and ketones were measured at baseline, 30 min post-supplement, post-steady-state exercise, and immediately following the time-trial. Plasma β-OHB was elevated from baseline and throughout the entire protocol in the ketone condition (p<0.05).

Kesl S L et al studied the effects of exogenous ketone supplementation on blood ketones in Sprague-Dawley rats (Nutr Metab (Lond). 2016 Feb. 4; 13:9. Doi:10.1186/s12986-016-0069-y.eCollection 2016). The supplements included: 1,3-butanediol (BD), a sodium/potassium β-hydroxybutyrate (βHB) mineral salt (BMS), medium chain triglyceride oil (MCT), BMS+MCT 1:1 mixture, and 1,3 butanediol acetoacetate diester (KE). Rats received a daily 5-10 g/kg dose of their respective ketone supplement via intra-gastric gavage during treatment. Weekly whole blood samples were taken for analysis of glucose and βHB at baseline and, 0.5, 1, 4, 8, and 12 h post-gavage, or until βHB returned to baseline. At 28 days, triglycerides, total cholesterol and high-density lipoprotein (HDL) were measured. RESULTS: Exogenous ketone supplementation caused a rapid and sustained elevation of βHB, reduction of glucose, and little change to lipid biomarkers compared to control animals.

Similar studies have indicated that acute ingestion of the (R)-3-hydroxybutyl (R)-3-hydroxybutyrate ketone monoester (Cox, et al. (2016). Cell Metab. 24, 256-268) can result in short-term (15 min to 6 hr) nutritional ketosis indicated by elevated (>1 mM) bHB.

In a double-blind, randomized crossover design, ten males and ten female participants performed two 75 g oral glucose tolerance tests (OGTT) on separate occasions, preceded by ingestion of either a flavored water placebo, or (R)-3-hydroxybutyl (R)-3-hydroxybutyrate ketone monoester (KME) (482 mg/kg) at 30 min before ingesting the glucose bolus. In the KME condition, blood βHB concentrations were elevated to ˜3 mM by the start of the OGTT and declined steadily to ˜1.5 mM by the end of the test. Notably, the plasma glucose AUC, the primary outcome measure, was reduced by 16% over the 2 h period. This occurred in the absence of a further elevation in insulin compared to glucose alone, but also coincided with a 44% reduction in 2 h AUC for serum FFAs. (Brendan Egan; The glucose-lowering effects of exogenous ketones: is there therapeutic potential? The Journal of Physiology, Accepted Article; doi: 10.1113/JP275938).

Vandrnberghe C et al study the effect of caffeine intake on plasma ketones levels. This study aimed to evaluate the acute ketogenic effect of 2 doses of caffeine (2.5; 5.0 mg/kg) in 10 healthy adults. Caffeine given at breakfast significantly stimulated ketone production in a dose-dependent manner (+88%; +116%) and it also raised plasma free fatty acids. Whether caffeine has long-term ketogenic effects or could enhance the ketogenic effect of medium chain triglycerides remains to be determined.

Furthermore, there is literature indicating the benefits of exogenous supplementation of ketone bodies in the reduction of blood glucose levels. Can J Physiol Pharmacol. 2017 April; 95(4):455-458. doi: 10.1139/cjpp-2016-0338. Epub 2016 Nov. 25. “Caffeine intake increases plasma ketones: an acute metabolic study in humans”

In a study by Shannon L. Kesi et al (Nutr. Metab (Lond) 2016; 13:9 Published online 2016 Feb. 4 doi: 10.1186/s 12986-016-0069-y) tested the effects of 28-day administration of five ketone supplements on blood glucose, ketones, and lipids in male Sprague-Dawley rats. The supplements included: 1,3-butanediol (BD), a sodium/potassium β-hydroxybutyrate (βHB) mineral salt (BMS), medium chain triglyceride oil (MCI), BMS+MCT 1:1 mixture, and 1,3 butanediol acetoacetate diester (KE). Rats received a daily 5-10 g/kg dose of their respective ketone supplement via intra-gastric gavage during treatment. Weekly whole blood samples were taken for analysis of glucose and βHB at baseline and, 0.5, 1, 4, 8, and 12 h post-gavage, or until βHB returned to baseline. At 28 days, triglycerides, total cholesterol and high-density lipoprotein (HDL) were measured. The study concluded that exogenous ketone supplementation caused a rapid and sustained elevation of βHB, reduction of glucose, and little change to lipid biomarkers compared to control animals.

Although there are methods to exogenously induce ketosis in the blood of mammals it involves dietary restrictions such as fasting or staying on a low-carbohydrate diet. There is a clear unmet medical need for effective and safe nutritional compositions to increase and maintain elevated levels of ketones in the blood circumventing impractical dietary restrictions. In this regard, an extensive interest exists within clinical and research communities to developed nutritional compositions comprising compounds that are essential to the diet in mammals and act to induce ketosis in mammals

### BRIEF SUMMARY OF THE INVENTION

The present invention provides a nutritional composition and methods to increase the level of ketones in the blood of mammals, including humans, thereby deliberately inducing ketosis.

In one embodiment, the present invention provides a nutritional composition and is related to the administration of the composition thereof to effectively increase and maintain ketone levels in the blood of mammals. Other embodiments analogous to the present invention would provide compositions related to the administration thereof in effectively increasing and maintaining ketone levels in the blood of mammals.

In one embodiment the composition comprises, Sodium Beta-Hydroxybutyrate, Potassium Beta-Hydroxybutyrate, Magnesium Beta-Hydroxybutyrate, Calcium Beta-Hydroxybutyrate, Medium Chain Triglycerides (MCT), L-Leucine, L-Lysine, L-Isoleucine, Ketone esters, Caffeine, Yohimbine, Yohimbe, Berberine, and Creatine or its derivatives. Exemplary creatine derivates are creatine salt and Creatyl-L-leucine.

The present invention provides methods for increasing ketones in the blood of mammals comprising administration of the compositions for two-eight weeks. The compositions may be administered orally. The compositions may be solubilized, dispersed or suspended in water or any other aqueous or oily carrier or vehicle with the aid of suitable solubilizing or dispersing agents. The administration of the compositions will result in effective and safe increase of ketones in the blood.

### DETAILED DESCRIPTION OF THE INVENTION

Unless defined otherwise, all technical and scientific terms used herein have the same meaning as commonly understood by one of ordinary skill in the art to which the invention pertains. Although any methods and materials similar or equivalent to those described herein can be used in the practice for testing of the present invention, the preferred materials and methods are described herein. In describing and claiming the present invention, the following terminology will be used.

It is also to be understood that the terminology used herein is for describing particular embodiments only and is not intended to be limiting.

The articles “a” and “an” are used herein to refer to one or to more than one (i.e., to at least one) of the grammatical object of the article. By way of example, “an element” means one element or more than one element. Thus, recitation of “a composition”, for example, includes a plurality of the compositions.

In one embodiment, the nutritional composition is in the form of a powder composition. This nutritional composition includes:

Sodium Beta-Hydroxybutyrate,

Potassium Beta-Hydroxybutyrate,

Magnesium Beta-Hydroxybutyrate,

Calcium Beta-Hydroxybutyrate,

Medium Chain Triglycerides (MCT)

Ketone esters, and

at least one component selected from the group consisting of L-Leucine, L-Lysine, L-isoleucine, Caffeine, Yohimbine, Yohimbe, Berberine and Creatine or its derivatives.

In an exemplary embodiment, the composition is in the form of a powder. An exemplary serving size of this powder composition is 27,050 mg of active ingredients, said active ingredients being sodium beta-hydroxybutyrate, potassium beta-hydroxybutyrate, magnesium beta-hydroxybutyrate, calcium beta-hydroxybutyrate, medium chain triglycerides, and at least one component selected from the group consisting of L-Leucine, L-Lysine, L-isoleucine, Caffeine, and Creatine or its derivatives.

In an exemplary embodiment, sodium beta-hydroxybutyrate is present in the powder composition for example in an amount of from 1700 mg, in particular 6.284%, based on the total weight of the composition of 27,050 mg.

In an exemplary embodiment, potassium beta-hydroxybutyrate is present in the powder composition for example in an amount of 130 mg, in particular 4.801%, based on the total weight of the composition of 27,050 mg.

Magnesium beta-hydroxybutyrate is present in the powder composition for example in an amount of 4545 mg, in particular 16.802%, based on the total weight of the composition of 27,050 mg.

Calcium beta-hydroxybutyrate is present in the powder composition for example in an amount of 5625 mg, in particular 20.795%, based on the total weight of the composition of 27,050 mg.

Medium chain triglycerides are present in the powder composition for example in an amount of 10000 mg as a 40% powder, in particular 36.969%, based on the total weight of the composition of active ingredients 27,050 mg. “Medium-chain triglycerides,” as used herein, would be as understood to the skilled artisan, for example as triglycerides whose fatty acids have an aliphatic tail of 6 to 12 carbon atoms. The preferred “Medium chain triglycerides” are grades that contain not less than 95% of caprylic triglyceride.

At least one component selected from the group consisting of L-Leucine, L-Lysine, L-isoleucine, Caffeine, and Creatine or its derivatives (for example creatine salt, and Creatyl-L-leucine) is present in the powder composition for example in an amount of 1 mg to 5000 mg, in particular from 0.037% to 18.5%, based on the total weight of the composition of active ingredients 27050 mg. The at least one component is in an example all four of L-leucine, L-lysine, creatyl-l-leucine, and caffeine. Creatyl-l-leucine, and methods for making it, are described, for example, in U.S. Pat. No. 8,445,466, the contents of which are incorporated herein by reference.

In an exemplary composition, the following amounts may be present (in mg, per 27050 mg of active ingredients):

TABLE 1

| | |
|---|---|
| Sodium Beta-Hydroxybutyrate | 1700 |
| Potassium Beta-Hydroxybutyrate | 130 |
| Magnesium Beta-Hydroxybutyrate | 4545 |
| Calcium Beta-Hydroxybutyrate | 5625 |
| L-Leucine | 3000 |
| L-Isoleucine | 1000 |
| L-Lysine HCl | 500 |
| Creatyl-L-Leucine | 250 |
| Caffeine Anhydrous | 300 |
| Medium Chain Triglycerides, 40% | 10000 |

Exemplary suitable ranges within the scope of this disclosure are presented in Table 2 below:

TABLE 2

| | Ranges |
|---|---|
| INGREDIENTS | mg/serving |
| Sodium Beta-Hydroxybutyrate | 1-15000 |
| Potassium Beta-Hydroxybutyrate | 1-15000 |
| Magnesium Beta-Hydroxybutyrate | 1-15000 |
| Calcium Beta-Hydroxybutyrate | 1-15000 |
| L-Leucine | 1-5000 |
| L-isoleucine | 1-5000 |
| L-Lysine HCl | 1-1000 |
| Creatyl-L-Leucine | 1-500 |
| Caffeine Anhydrous | 1-350 |
| Medium Chain Triglycerides | 1-12000 |

Further exemplary suitable ranges within the scope of this disclosure are presented in Table 3 below:

TABLE 3

| | Ranges |
|---|---|
| INGREDIENTS | mq/servinq (27.05 g) |
| Sodium Beta-Hydroxybutyrate | 1000-5000 |
| Potassium Beta-Hydroxybutyrate | 100-1000 |
| Magnesium Beta-Hydroxybutyrate | 1000-5000 |
| Calcium Beta-Hydroxybutyrate | 1000-5000 |
| L-Leucine | 1000-5000 |
| L-isoleucine | 1000-5000 |
| L-Lysine HCl | 100-1000 |
| Creatyl-L-Leucine | 100-500 |
| Caffeine Anhydrous | 200-350 |
| Medium Chain Triglycerides | 8000-12000 |

The physiologically active compounds contemplated for use herein are included in the nutritional composition in an amount sufficient to produce the desired effect upon the target process, condition or disease. In addition, such compositions may optionally contain one or more agents selected from flavoring agents (such as peppermint, oil of wintergreen or cherry), coloring agents, preserving agents, and the like, in order to provide pharmaceutically elegant and palatable preparations. Suspensions of the present invention may contain wetting agents, suspending agents, buffers, preserving agents, flavors and sweeteners (sucralose, acesulfame potassium).

As described above, the instant composition may, for example, be in powder form. This powder composition can be prepared by mixing each component in powder form in a suitable blender or planetary mixer and mixing the ingredients for the time necessary to obtain a uniform and homogeneous mixture.

The mixture can then optionally be packaged into jars in a quantity that represents a defined number of servings. A measuring scoop can be added to the jar for the purpose of providing an accurate serving.

The powder composition described above may be ingested orally as a powder composition. In the alternative, a user may scoop a serving of the powder from the jar and mix it with room-temperature water, the powder can also be mixed with any other beverage to provide a suspension. It can also be added and mixed into a fruit sauce, yogurt or pudding.

In one embodiment, the composition comprises 1 to 4.8 grams of medium chain triglycerides per 100 grams of the nutritional composition.

In one embodiment, the invention is directed to a method of inducing ketosis in a mammal by administering the composition described above. The mammal may, for example, be a human. The administration can, for example, be oral administration, for example by ingestion of a beverage, fruit sauce, yogurt, or pudding into which the composition described above has been mixed.

The administration may optionally be chronically for a set period-of-time, for example from two to eight weeks. As used herein, “chronically” means repeated ingestion over a period of several days, several weeks, even several months, or longer. Acute (non-chronic) administration may also be utilized. Whether chronically or non-chronic, it is meant that the composition is orally ingested one time per day, either in powder form or mixed with a beverage, fruit sauce, yogurt, pudding, or other liquid composition. The amounts given in Table 1 indicate relative amounts of each component which may be present in a single serving, said single serving optionally being ingested one or more times a day, optionally mixed with a single serving of a beverage, fruit sauce, yogurt, or pudding. The skilled artisan will understand the standard serving size of each of the above.

For example, a single serving of the powder composition as set forth above and as exemplified in Table 1 may be mixed with a single serving of yogurt, for example one cup of yogurt. The same single serving may be mixed with a single serving of pudding, for example one half cup. An exemplary serving size for water or a beverage with which the single serving powder composition may be mixed would be eight ounces.

In a specific embodiment, the subject invention provides aqueous compositions into which the powder composition has been mixed, suitable for oral administration to mammals including, without limitation, humans. To prepare a composition according to one embodiment of the invention, a desired amount of each component of the composition is added to a selected volume of water or beverage, and sufficient stirring is effected to cause a dispersion of the powder composition to create an aqueous composition.

A composition according to this invention may also include other ingredients such as, for example, flavoring agents, colorants, viscosity modifiers, preservatives, chelating agents, antioxidants, surface modifiers and other nutritional adjuvant materials. Other materials include any substance that is generally recognized as promoting the health or function of a mammalian organism, including humans, or benefiting a composition useful thereof in terms of its efficacy, appearance, stability, consistency, aroma, or viscosity. Such substances include, for example, other amino acids and their salts, vitamins, minerals, fatty acids, enzymes, mono-glycerides, di-glycerides, tri-glyceride ester oils (including, for example, vegetable oils and animal fats) emulsifiers, hydrolyzed proteins, whey protein, stabilizers, flow modifiers, viscosity improvers, chelating agents, enzymes, and surfactants (whether anionic, cationic or nonionic). The total amount of these materials in a composition can be any amount between about 0.01% and about 50% by weight based on the total weight of said composition, including all percentages and ranges of percentages therebetween.

A composition according to this invention may also comprise one or more natural or synthetic beverages. For example, a natural beverage may contain the pulp, juice or any other constituent of a naturally-occurring fruit, vegetable, or animal product whether from the wild, cultured, cultivated on a farm or otherwise domesticated.

Natural beverages include, without limitation, materials such as milk products, soy products, ice cream, yogurt, citrus fruit juices, non-citrus fruit juices, and vegetable juices, or components of any of the foregoing, wherein said natural beverages are present in any effective amount to impart flavor to the compositions, which may be any amount between about 0.1% and about 99% by weight based on the total weight of said composition, including all percentages and ranges of percentages there between.

Thus, it is evident that a composition according to this invention may be made quite palatable to a mammalian subject, including a human. Serving sizes may be any serving size in the range of about 1 milligram to about 50 grams, in an aqueous solution that is from about 20 ml to about 2,500 ml in volume. Thus, for example, 1 milligram to about 50 grams, in particular 27,050 mg, of the powder composition described above may be mixed with 20 ml to about 2,500 ml of water, juice, or other liquid composition, in particular 68 mL of water, juice, or other liquid composition. This admixing creates the oral composition which may be taken as set forth above. Such oral composition can provide a concentrate from which the required amount of each component may conveniently be provided.

The compositions of the subject invention can be formulated for a variety of modes of administration. These formulations include, but are not limited to, compositions for oral administration, emulsion compositions, gel formulations, oral solid compositions, and oral liquid compositions, or with protein.

It has been found that oral administration of the compositions according to the invention are effective to induce ketosis in mammals, for example in humans.

### Example

The inventor conducted a double-blind, placebo-controlled, crossover study in 12 subjects. Protocol: Subjects were fasted on the day of the test. A base line was established using a Precison Xtra™ Blood Glucose and Ketones Monitoring System (Abbott Laboratories, Abbott Park, Ill.). On alternate days, subjects received either 1 serving of placebo or 1 serving of the composition subject of this disclosure (see Table 1 above). Placebo consisted of 1 serving of 12 g of beta-hydroxybutyrate salts (calcium, magnesium, potassium and sodium beta-hydroxybutyrate). Subjects were rested and readings were obtained after 1, 1.5 and 2 hours. Results: After 1 hour the level of ketones in the blood for subjects in the placebo group increase from 0.267 millimoles/L to 0.7 millimoles/L, while on the subjects in the composition group it increased from 0.275 millimoles/L to 2.05 millimoles/L. The levels decrease thereafter down to 0.358 millimoles/L for the placebo group but it maintained levels of ketones in the blood 1.317 millimoles/L after 1.5 hours and 0.908 after 2 hours in the group of the composition. Conclusion: the composition of this application increases blood ketones levels above 0.5 millimoles/L after 1 hour and sustain blood ketones levels above 0.5 millimoles/L for at least 2 hours.

All references discussed herein are incorporated by reference. One skilled in the art will readily appreciate that the present invention is well adapted to carry out the objects and obtain the ends and advantages mentioned, as well as those inherent therein. The present invention may be embodied in other specific forms without departing from the spirit or essential attributes thereof and, accordingly, reference should be made to the appended claims, rather than to the foregoing specification, as indicating the scope of the invention.

1. A nutritional composition comprising:
Sodium Beta-Hydroxybutyrate,
Potassium Beta-Hydroxybutyrate,
Magnesium Beta-Hydroxybutyrate,
Calcium Beta-Hydroxybutyrate,
Medium Chain Triglycerides (MCT)
Ketone esters, and
at least one component selected from the group consisting of L-Leucine, L-Lysine, L-isoleucine, Caffeine, Yohimbine, Yohimbe, Berberine, and Creatine or its derivatives.

2. The nutritional composition of claim 1 wherein the composition comprises 1 to 4.8 grams of medium chain triglycerides per 100 grams of the nutritional composition.

3. The nutritional composition of claim 1, wherein the composition comprises L-Leucine, L-lysine, L-isoleucine, caffeine, and at least one of creatine salt and creatyl-l-leucine.

4. The nutritional composition of claim 1, wherein the composition comprises, the following amounts in mg per 27.05 g serving:

| | |
|---|---|
| Sodium Beta-Hydroxybutyrate | 1-15000 |
| Potassium Beta-Hydroxybutyrate | 1-15000 |
| Magnesium Beta-Hydroxybutyrate | 1-15000 |
| Calcium Beta-Hydroxybutyrate | 1-15000 |
| L-Leucine | 1-8000 |
| L-isoleucine | 1-7000 |
| L-Lysine HCl | 1-10000 |
| Creatyl-L-Leucine | 1-7000 |
| Caffeine Anhydrous | 1-800 |
| Medium Chain Triglycerides (40%) Powder | 1-12000 |

5. The nutritional composition of claim 1, wherein the composition comprises, the following amounts in mg per 27.05 g serving:

| | |
|---|---|
| Sodium Beta-Hydroxybutyrate | 1000-5000 |
| Potassium Beta-Hydroxybutyrate | 100-1000 |
| Magnesium Beta-Hydroxybutyrate | 1000-5000 |
| Calcium Beta-Hydroxybutyrate | 1000-5000 |
| L-Leucine | 1000-5000 |
| L-isoleucine | 1000-5000 |
| L-Lysine HCl | 100-1000 |
| Creatyl-L-Leucine | 100-500 |
| Caffeine Anhydrous | 200-350 |
| Medium Chain Triglycerides (40%) Powder | 800-12000 |

6. The nutritional composition of claim 1, wherein the composition is in the form of a powder.

7. The nutritional composition of claim 1, wherein the composition is in the form of an orally administrable liquid composition.

8. The nutritional composition of claim 7, wherein the orally administrable liquid composition comprises water, fruit juice, yogurt, or pudding.

9. The nutritional composition of claim 4, wherein the composition is in the form of a powder.

10. The nutritional composition of claim 4, wherein the composition is in the form of an orally administrable liquid composition.

11. The nutritional composition of claim 10, wherein the orally administrable liquid composition comprises water, fruit juice, yogurt, or pudding.

12. A method comprising administering an effective amount of the nutritional composition of claim 1 to a mammal in need thereof, thereby inducing ketosis in the mammal.

13. A method comprising administering an effective amount of the nutritional composition of claim 2 to a mammal in need thereof, thereby inducing ketosis in the mammal.

14. A method comprising administering an effective amount of the nutritional composition of claim 4 to a mammal in need thereof, thereby inducing ketosis in the mammal.

15. The method of claim 12, wherein the composition is administered over a period of treatment of 2-8 weeks.

16. The method of claim 15, wherein the nutritional composition is in powder form and wherein the administering comprises dispersing the composition in water or in a suspension in a suitable aqueous liquid vehicle or carrier to form a liquid composition, and orally ingesting the liquid composition, or in a snack composition.

17. The method of claim 15, wherein the nutritional composition is in powder form and wherein the administering comprises adding the nutritional composition to a fruit juice, yogurt or pudding.
